(19) United States
(12) Patent Application Publication
(10) Pub. No.: US 2005/0063131 A1
(43) Pub. Date: Mar. 24, 2005

(54) Controller for electrostatic spray gun internal power supply

(76) Inventor: Jeffrey A. Perkins, Amherst, OH (US)

Correspondence Address: Douglas B McKnight;Calfee Halter & Griswold, Suite 1400, 800 Superior Avenue, Cleveland, OH, 44114, US

(21) Appl. No.: 10/502,666

(22) PCT Filed: Feb. 10, 2003
(86) PCT No.: PCT/US03/03924

Related U.S. Application Data
(60) Provisional application No. 60/356,214, filed on Feb. 12, 2002.

(51) Int. Cl. H05B 1/00

(52) U.S. Cl. 361/227

(57) ABSTRACT

An internal power supply for an electrostatic application device includes a programmable digital control circuit (104) that produces a time variant drive signal (106) to a high voltage multiplier circuit (108). The internal power supply is fully installed inside the device so that only a fixed low DC voltage input (16) is needed for the power supply. The control circuit (104) may optionally utilize stored characteristic parameters of the power supply as well as feedback signals that correspond to operational characteristics of the power supply during a spraying operation.

### RELATED APPLICATION

This application claims the benefit of U.S. provisional patent application Ser. No. 60/356,214 filed on Feb. 12, 2002 for MULTIPLIER WITH INTERNAL MICROPROCESSOR CONTROL, the entire disclosure of which is fully incorporated herein by reference.

### FIELD OF THE INVENTION

The invention relates generally to electrostatic spray systems, and more particularly, to a power supply having a digital or programmable control circuit with the power supply being adapted as an internal power supply for an electrostatic spray gun.

### BACKGROUND OF THE INVENTION

Electrostatic spray systems apply coating material such as liquid or powder paints and coatings to a variety of products including, for example, appliances, automotive components, metal office furniture/storage shelving, electrical transformers, and recreational equipment. One type of electrostatic spray gun is a corona gun. In many corona guns, an internal power supply charges a gun electrode to a high voltage which produces an intense electric field between the spray gun and a part to be painted. The coating material, such as, for example powder, is sprayed through the area of the electric field. Passing through this area, the powder particles are charged and are drawn to the usually grounded part to be painted. In this manner, the part to be painted is coated with powder paint.

The basic components of such spray systems are a spray gun and a spray gun controller, and more particularly, the internal power supply for the spray gun and the external control of that internal power supply by the spray gun controller. By an “internal” power supply is simply meant that the power supply is disposed within the spray gun housing. In prior art systems, the spray gun controller, and in particular the controller for the spray gun internal power supply, is an external controller meaning that the controller and related circuits are external to the spray gun and communicate with the spray gun and the internal power supply via a cable or wire.

In such prior art systems, a conventional internal power supply includes a resonant oscillator and a voltage multiplier circuit. The resonant oscillator produces a periodic or oscillatory drive signal to the multiplier. The multiplier typically includes a voltage step-up transformer and a series of capacitor-diode stacks that increase the power supply output voltage to the range of about 30 Kilovolts (KV) to about 100 Kilovolts (KV) or more. A commonly used multiplier design is a Cockroft-Walton bridge circuit.

The voltage multiplier of an internal power supply typically exhibits characteristic relationships between the output and input under various load conditions. The external controller is designed to provide an appropriate excitation voltage to the oscillator so as to control the operation of the internal power supply within a desired range of efficiency and safety. Typical internal power supplies operate in response to a variable low DC voltage input drive signal in the range of about 5-21 volts. Known external controllers may use a load current feedback signal to adjust the input drive signal so as to improve power supply efficiency and reduce power supply overload conditions, or may simply provide a fixed drive signal that allows the power supply to operate effectively over the expected load ranges.

A limitation with known external controllers as used with internal power supplies is that the controller is designed based on an expected performance and operating characteristics of the internal power supply. This means that a set of predetermined drive voltages and drive currents are used to drive the power supply associated with each spray gun, and likewise, feedback current information from the power supply is used to monitor and control the respective power supply in a predetermined manner. In fact, however, there may be a great deal of variance between individual power supplies. Power supplies are built from capacitors and diodes and other components which are potted. There is often a variation between these components due to normal manufacturing tolerances, and in the potting material as well. Consequently, there is often variation in the drive voltage and drive current under different load conditions and environmental conditions such as temperature which is necessary to produce a given electrostatic effect from one spray gun to another spray gun of the same model. The large number of variations, even those well within normal tolerances of the components, make diagnostic analysis difficult when only a limited amount of information is available to an external controller. Up to now, external controllers have been incapable of distinguishing between power supplies since no information has been provided which can be used to identify individual performance parameters with each power supply.

Moreover, use of an external controller severely limits the response time of the internal power supply. Known internal power supplies are built with a very high input filter capacitance in order to smooth out the DC input drive voltage and to prevent excessive loads on the external supply. The internal power supply input impedance often includes diodes to prevent reverse discharge. Because of the diodes, time is required to discharge the filter capacitance in order to change the power supply operation. This time is due to the fact that the diodes force the input capacitance to discharge through the output of the multiplier which has a very high output impedance. The high input impedance of a typical internal power supply necessarily dictates that the power supply will only respond to input drive voltage changes at a rather slow rate, such as 50-100 milliseconds. This slow response rate typically is too slow for the external controller to adequately control operation of the power supply such as for unwanted oscillations or rapidly changing load conditions. The result may be an inefficient operation of the power supply and a decrease in the useful life of the power supply due to overload stress. Still further, an external controller is severely limited in the amount of information it can receive from the internal power supply as it must communicate therewith over separate wires. The use of a large number of wires coming out of a high voltage spray gun is typically avoided, therefore, external controllers are very limited in the amount of feedback information received as well as the response time to effect changes even if such information were available.

### SUMMARY OF THE INVENTION

In accordance with the present invention, improved control and operation of an internal power supply of an electrostatic application device, such as for example an electrostatic spray gun, can be achieved by incorporating power supply control functions into the power supply itself, thereby eliminating the need for an external controller. The internal power supply is adapted for installation into an electrostatic spray gun. In one embodiment, a digital or programmable control circuit is incorporated into the internal power supply. The control circuit provides a drive signal in lieu of a resonant oscillator. In one embodiment, the drive signal produced by the control circuit is a time variant or oscillating signal, for example. The time variant drive signal is input to a voltage multiplier that produces an increased voltage output for an electrode in the spray gun. In accordance with another aspect of the invention, the internal control circuit provides a drive signal to the multiplier such that the multiplier produces an output voltage from about 0 KV to at least 30 KV or greater.

In accordance with another aspect of the invention, an internal power supply for an electrostatic spray gun includes a control circuit for driving a voltage multiplier wherein the control circuit operates from a low DC voltage power supply input from an external source. In one embodiment, the low DC input is a fixed voltage, and an optional voltage regulator internal the power supply may be used to provide a steady supply voltage to the control circuit. Use of a voltage regulator also allows operation of the input voltage source to be within an allowed range because there is no longer a required relationship between the input voltage to the internal power supply and the output of the internal power supply. Operation of the power supply is controlled internal to the application device without a required external control, so long as the input voltage is within the allowed operating range.

In accordance with another aspect of the invention, an internal power supply for an electrostatic spray gun includes an internal control circuit that stores and utilizes information related to the characteristic parameters of the power supply. In an additional embodiment, the control circuit receives and utilizes feedback information related to operational characteristics of the power supply during operation thereof. The feedback information may be used separately or in combination with the stored information of parametric characteristics of the power supply.

In accordance with another aspect of the invention, improved control and operation of an internal power supply for an electrostatic spray gun is achieved by providing a digital or programmable control circuit that is incorporated into the power supply and that produces an oscillating drive signal from a fixed voltage input to the power supply, with the power supply being adapted for installation into a spray gun. The oscillating drive signal is input to a voltage multiplier that produces a high voltage output for an electrode in the spray gun. The fixed voltage input may be internally or externally generated with respect to the spray gun.

In accordance with another aspect of the invention, improved control and operation of an internal power supply for an electrostatic spray gun is achieved by providing a digital or programmable control circuit in the power supply for controlling operation thereof and that is adapted for installation into the spray gun, wherein the internal control circuit communicates with a circuit external the spray gun.

In accordance with another aspect of the invention, the above identified aspects of an internal power supply can be used with an electrostatic application device as part of an electrostatic coating material application system, such as typically includes, in one embodiment, one or more electrostatic spray guns connected to a coating material supply, with the spray gun optionally disposed within a spray booth or other suitable enclosure for spray coating objects. The coating material may be liquid, powder or other suitable media applied to an object by an electrostatic application process.

These and other aspects and advantages of the invention will be understood and appreciated by those skilled in the art from a reading of the following detailed description of exemplary embodiments of the invention and the accompanying drawings.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of this invention.

FIG. 1 is a functional block diagram of an electrostatic application system that utilizes one or more aspects of the present invention;

FIG. 2 is a simplified functional block diagram of an internal power supply of a spray gun in accordance with the invention such as may be used in the system of FIG. 1;

FIG. 3 is a functional block diagram of one embodiment of an internal control circuit for an internal power supply such as used in the embodiment of FIG. 2;

FIG. 4 is an electrical schematic of an exemplary embodiment of the internal power supply of FIG. 2;

FIG. 4A is a schematic diagram of an exemplary feedback circuit used with the embodiment of FIG. 4, and

FIG. 5 is a simplified representation of an electrostatic application device arrangement suitable for use with the present invention.

### DETAILED DESCRIPTION OF ILLUSTRATED EMBODIMENT

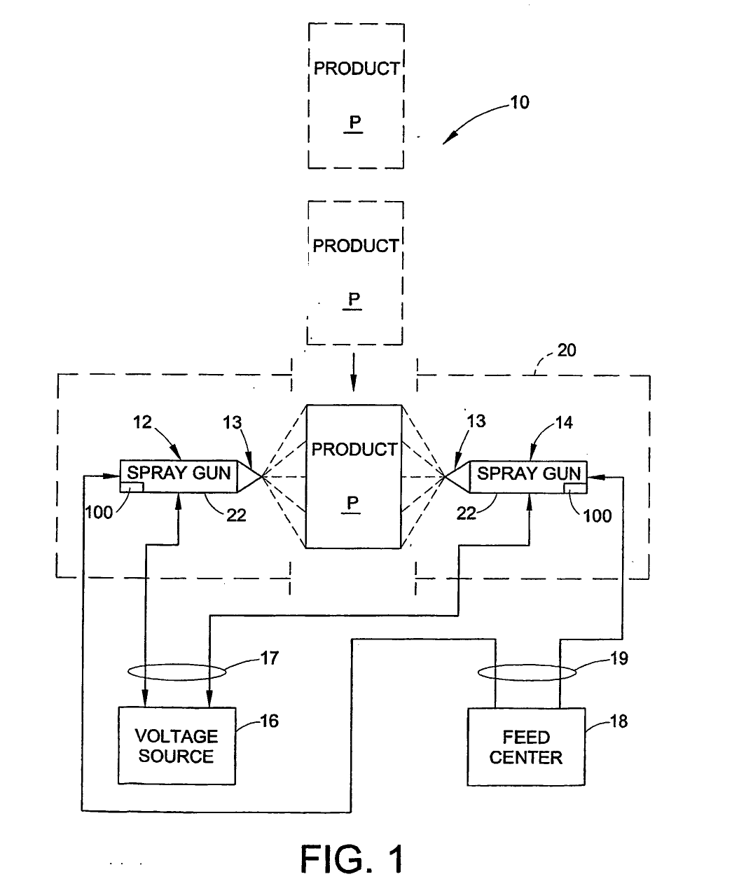

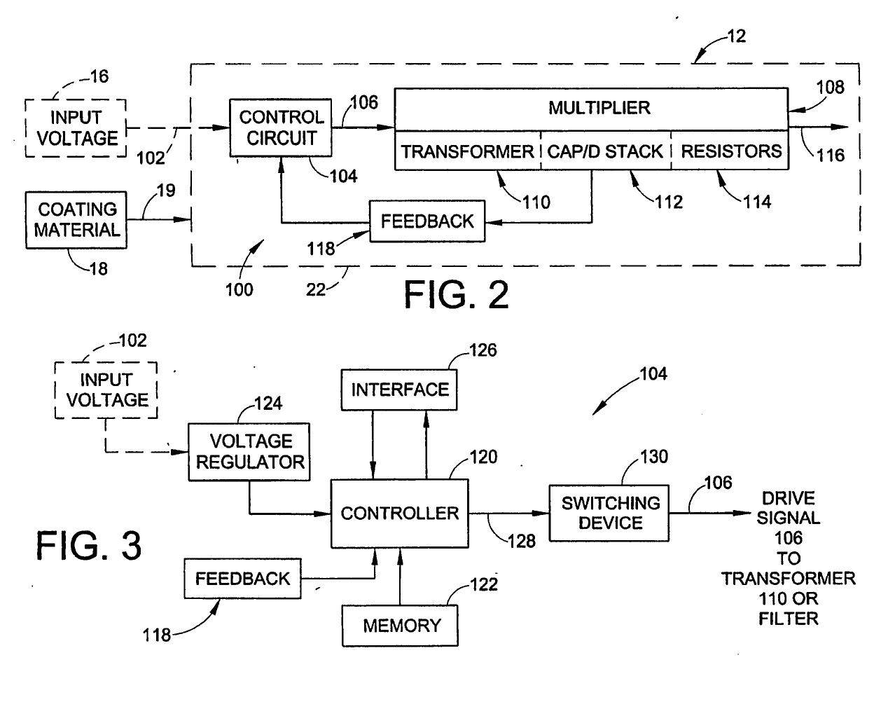

Referring now to FIG. 1, an overview of an electrostatic application system 10 will now be discussed. The electrostatic application system 10 generally includes, for example, one or more application devices, such as, for example, electrostatic spray guns 12 and 14 that are in electric circuit communication with an external voltage source 16. The circuit communication is preferably via shielded and insulated wire conductors 17. The one or more spray guns 12 and 14 are also in fluid communication with a coating material feed center 18. The coating material may be liquid, powder or any other suitable media that is compatible with the application devices. The fluid communication is via one or more hoses or lines 19. Product or parts P to be sprayed or coated enter the electrostatic application system 10 through an opening in a booth 20 or other suitable enclosure. Parts may in some cases also be coated other than in a booth or enclosure. In the booth 20, the product P is sprayed by the electrostatic spray guns 12 and/or 14 via a spray nozzle 13 and a charging electrode 116 (FIG. 2). Other components (not shown) such as, for example, a compressed air source, part conveyors, gun mounting arrangements and so on, are typically also part of an electrostatic application system 10. More detailed examples of electrostatic application systems are described in U.S. Pat. No. 5,788,728 to Solis, U.S. Pat. No. 5,743,958 to Shutic, U.S. Pat. No. 5,725,670 to Wilson et al., U.S. Pat. No. 5,725,161 to Hartle, and U.S. Pat. No. 5,566,042 to Perkins, all of which are fully incorporated herein by reference.

The electrostatic spray gun can also be either manual or automatic. Manual spray guns are held and triggered by a hand painter. Examples of manual spray gun systems include the SURE COAT® Manual Spray Gun System that is manufactured by Nordson Corp. of Westlake, Ohio. Automatic spray guns are triggered by a controller. Automatic guns may be fixed, or supported on gun movers. Examples of automatic spray gun systems include the VERSA-SPRAY® II Automatic Spray System and the VERSA-SPRAY® II PE Porcelain Enamel Spray System with SURE COAT® Control, all manufactured by Nordson Corp. of Westlake, Ohio. Examples of various spray guns suitable to the present invention are described in U.S. Pat. No. 6,375,094 B1 to Schroeder et al., U.S. Pat. No. 5,938,126 to Rehman et al., U.S. Pat. No. 5,908,162 to Klein et al., U.S. Pat. No. 5,904,294 to Knobbe et al, U.S. Pat. No. 5,816,508 to Hollstein et al., U.S. Pat. No. 5,725,161 to Hartle, all disclosures of which are hereby fully incorporated by reference. In addition to the above-cited examples, the present invention in general is applicable to any type of spray gun utilizing corona charging or corona charging with tribocharging. In particular, however, the invention is especially useful with corona-type guns having integral power supplies.

It is important to note that although the exemplary embodiments herein are described in terms of a corona-type electrostatic powder spray gun, such description is intended to be exemplary in nature and should not be construed in a limiting sense. The various aspects of the present invention may be used with any electrostatic application device and in many different electrostatic application systems. The present invention is thus not limited in any manner to a particular application device configuration such as manual or automatic, positive charging or negative charging, or any particular spray booth, feed or supply system or coating material description. The present invention may also be used with combination devices such as, for example, electrostatic application devices that utilize corona charging and tribocharging features. Additionally, although various embodiments and aspects of the present invention may be described herein both as alternative embodiments as well as in various combinations, sub-combinations and uses, such descriptions should not be construed in a limited sense. The various aspects, advantages and/or embodiments of the invention may be used individually or in various combinations and sub-combinations within the scope of the present invention.

With reference to FIG. 2, the spray gun 12 may include an external housing 22 that encloses various electronic and mechanical parts of the spray gun, such as a spray nozzle, valves, switches and so on. A suitable hose 19 is used to provide coating material to the gun 12 from the feed center 18 or other suitable source of coating material. Compressed air may also be supplied to the spray gun as needed (not shown). As illustrated schematically in FIG. 2, a spray gun in accordance with the invention utilizes an internal power supply 100 that simplifies electrical connections to the spray gun. Alternatively, however, as will be described herein, the internal power supply 100 may be configured to also communicate with an external circuit if so desired, such as for example to permit operator inputs, overrides, feedback and offline data analysis to name a few examples. Preferably, in one embodiment, the internal power supply 100 is configured to be a self-contained control for electrical operation of the spray gun 12. The internal power supply 100 operates from a fixed voltage input 102, such as for example a 24 volt DC power supply 16. Alternatively, the voltage input 102 may operate within an acceptable range, such as for example 10-30 volt DC, when an internal voltage regulator is provided within the internal power supply 100. The value of the input 102 will be determined by the power requirements of the supply 100. The voltage input 102 may be a power source that is external the spray gun as illustrated in FIG. 2, or may in some cases may be internally generated. An important aspect is that preferably the internal supply 100 does not require any externally varying input as part of the control function, as is the case in the prior art.

The internal power supply 100 will typically although need not be a self-contained unit retained in its own housing or casing and suitably potted for shielding and insulation. Regardless of the assembly technique used, in accordance with the invention the internal power supply 100 is adapted to be installed in the spray gun housing 22 for use during normal application operations. The various sections and components of the power supply 100 may be installed into the spray gun in any required or suitable manner and need not necessarily be in a common casing or in a single space within the gun housing.

The internal power supply 100 can conceptually be divided into three basic sections for ease of explanation. These are a control circuit 104, a multiplier section 108 and a feedback section 110. Those skilled in the art however will readily appreciate that the various components in an actual power supply may be assembled in a wide variety of configurations.

The control circuit 104 may be realized in the form of a digitally programmable controller circuit, such as, for example, a microprocessor, microcontroller or DSP (digital signal processing) based control circuit. In accordance with one aspect of the invention, the control circuit 104 replaces the resonant oscillator as used in prior art systems, and is programmable to produce an oscillating or otherwise time variant output drive signal 106 that is received at an input to a multiplier circuit 108. The ability to digitally or otherwise internally control the drive signal allows the control circuit 104 to vary the frequency of the drive signal to optimize efficiency of the power supply. By utilizing a programmable control circuit 106 to produce the drive signal for the multiplier 108, the internal power supply 100 obviates the need for any externally variant input but rather is controlled internally. The external input 102 can be nothing more than a simple unregulated power supply. Since the internal control circuit 104 does not depend on any external control signal, the ability of the control circuit 104 to respond to changing conditions within the power supply, such as load, temperature and so on and to effect rapid changes in the operating parameters of the power supply is greatly increased. For example, whereas in the prior art an internal power supply could respond to external control functions in the millisecond range, an internally controlled power supply in accordance with the invention can respond in the microsecond range. Additionally, and in alternative embodiments, the control circuit 104 may include memory capacity for storing power supply operating characteristic parameters and data for use in comparison with real time operating data as part of a diagnostics capability. The use of an internal programmable controller 104 also greatly increases the diagnostic monitoring and response time capabilities of the internal power supply 100 as there is no need for external connections to an external controller.

The multiplier section 108 may be conventional in design, and as such may include a step-up transformer 110 and a multiplication circuit 112 such as for example a Cockroft-Walton bridge circuit having a series of capacitor diode stacks. One or more resistors 114 may also be used as is known to limit output current to the high voltage electrode 116 of the spray gun.

The third or feedback section 118 of the internal power supply is a suitable arrangement for providing feedback signals relating to the operational performance of the power supply 100, and although optional, the feedback circuitry 118 typically will be used in order to utilize fully the capabilities of the control circuit 104. For example, by monitoring load current, the control circuit 104 can adjust the input drive signal 106 so as to prevent overload conditions or to modify the operation of the power supply 100 to increase efficiency by adjusting the load line characteristics of the supply in response to changing load conditions. Since the feedback signals and the control function are all internal to the power supply 100, very fast response times can be achieved without having to rely on the exchange of signals with an external controller. Still further, the use of a controlled variable frequency oscillator, as distinguished from a resonant oscillator for example, allows the control circuit 104 to optimize power supply efficiency by adjusting the drive frequency in response to the stored parametric characteristics as well as the feedback information.

With reference to FIG. 3, in an exemplary embodiment, the control circuit 104 includes a programmable controller 120 such as any one of a large number of commercially available microcontrollers, microprocessors or DSP circuit to name a few examples, as are well known to those skilled in the art and can be programmed in a conventional manner. The controller 120 includes or is in communication with a memory unit 122. The memory may be programmed, for example, at the manufacturer to include operational parameters, data and information such as, for example, no load drive current, mid-load drive current, maximum load drive current, turn-on voltage, short circuit drive current, temperature range parameters and power supply response under temperature, and so on to name a few examples. Still further, a manufacturer may define the operation of the power supply with data and information that define the relationship between power supply input and output characteristics under various load conditions. These relationships can often be defined in terms of a series of mathematical equations and data, which information may be stored in the memory unit 122 to be used for controlling the power supply as the load varies. This is particularly useful, for example, under low load conditions wherein the relationships between the feedback voltage and the load current can be highly non-linear. See for example, U.S. Pat. No. 5,566,042 which is fully incorporated herein by reference. The stored data may also include such information as the type of power supply, manufacturer identification data, useful life data and so on. The controller 120 is programmed to utilize this data as part of its control function of the operation of the internal power supply 100.

A suitable voltage regulator 124 receives the external fixed input voltage 102 (shown in phantom in FIG. 3 as in this embodiment it is considered to be generated external the spray gun) and provides a regulated supply voltage for the electronic components of the control circuit 104. An interface circuit 126 may be used in a conventional manner to permit an operator or other person to input various control parameters or data if so required, such as through any suitable Input/Output (I/O) device like a keyboard, infrared (IR) port, serial port and so on. The interface 124 may also be used to send data to an external computer or other device for analysis (not shown). As noted in phantom in FIG. 3, the controller also receives the feedback signals 118, suitably formatted for input to the controller 120.

The controller 120 produces in this case an oscillating or other time variant signal 128 such as, for example, a pulse width modulated (PWM) signal that is used to drive a suitable switching device 130. The switching device 130 may be, for example, an FET or other preferably solid state switching device having an output that is the drive signal 106 to the multiplier 108 (FIG. 2). By utilizing PWM or other suitable digitally controlled signals, the controller 120 can effect input drive changes to the multiplier 108 so as to control operation of the power supply 100 with very fast response times comparable to the response times of the switching device 130. Since all decision making is performed internal to the power supply 100, overall control and response times is orders of magnitude faster than the known prior art.

The drive signal 106 output from the switching device may be, for example, a PWM signal that is filtered, such as with a conventional Pi-filter, to produce a low harmonic sinusoidal drive signal to the multiplier transformer 110.

It should be noted that in accordance with another aspect of the present invention, utilizing a programmable control circuit in lieu of a resonant oscillator permits control of the output voltage from the power supply to vary from as low as 0 KV to its maximum rated voltage or higher. Resonant oscillators typically require a minimum input voltage before they start running, and this in turn limits the voltage output of the multiplier to about 30 KV or higher. Using a programmable controlled drive signal allows control of the output voltage to 0 KV.

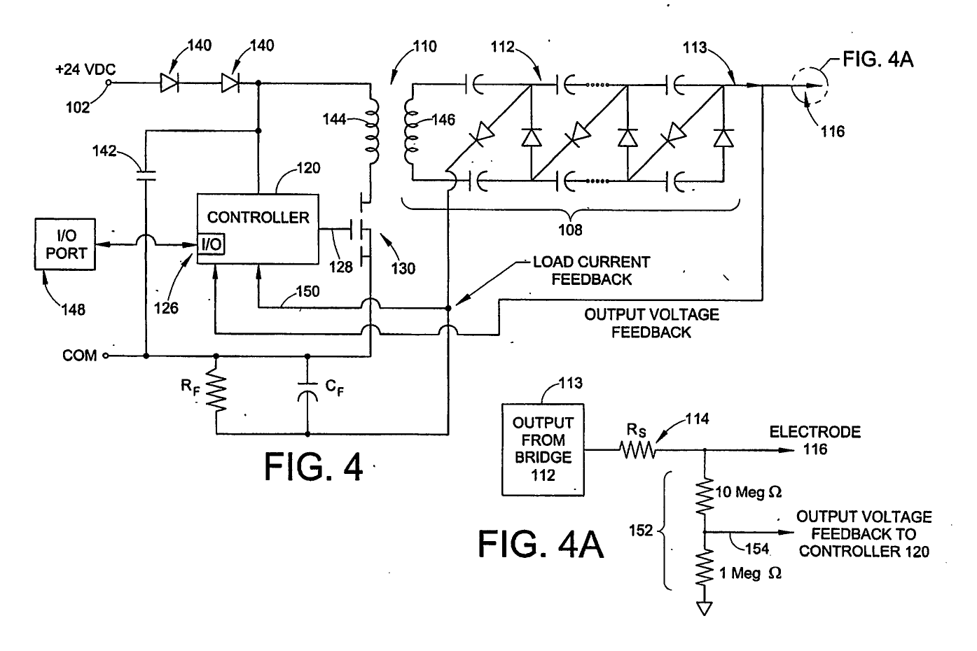

With reference to FIG. 4, an exemplary embodiment of an internal power supply for use with an electrostatic application device is shown. Many alternative embodiments will be readily apparent to those skilled in the art and are considered to be within the scope of the present invention. The regulator 124 is realized in the form of input diodes 140 and a filter capacitor 142. The controller 120 drives an FET switching device 130 that is coupled to the primary winding 144 of the step-up transformer 110. A secondary winding 146 of the transformer 110 is coupled to the multiplier 112, in the form of a Cockroft-Walton bridge circuit. The multiplier 112 output 113 is coupled to the output electrode 116 of the application device. Typically, one or more series resistors Rs (FIG. 4A) are coupled between the multiplier output 113 and the electrode 116 to limit load current and reduce the chance of arcing.

The controller 120 includes any number of optional I/O port devices 126 that communicate with an external device or devices 148 if required. A feedback resistor R_{F} is coupled to the multiplier circuit 108 to produce a feedback signal 150 that corresponds to the load current (a filter capacitor C_{F} may also be used as shown). As shown in FIG. 4A, another feedback resistor series 152 may be used to produce an output voltage feedback signal 154. Both feedback signals 150, 154 are input to the controller 120. The use of feedback is optional but greatly enhances the control function of the controller 120 over the operation of the power supply 100.

Once the operational parameters of a spray gun and internal power supply are determined, such as for example during manufacturing testing, the control circuit 104 stores these parameters and gun type identification data in the memory 122. A user input device is preferably used to input alpha-numerical information through a keyboard or similar keypad and/or other information that can be provided by a mouse or other pointing device(s) via the interface 126. A display device (not shown) may be used to display information generated from the system and preferably includes CRT or LCD displays. A display may also be included on the spray gun itself, along with manual control switches for manual inputs to the control circuit 104.

In operation, information read from the internal power supply 100 includes the power supply operating parameters such as, for example, minimum drive current, maximum drive current, and feedback current information. The minimum drive current parameter would represent the lowest level of current, for a given drive voltage, which is required for the power supply to be operation under no-load conditions. The maximum drive current parameter would represent the level of current required, for a given drive voltage, which is required to operate in the power supply under a specified fully loaded condition. These two parameters would define the drive current operating window for the power supply at the given drive voltage. Therefore, during normal operation, the controller 120 compares these parameters to the actual drive current. If the drive current falls outside of these windows, it would indicate to the controller that the power supply is operating abnormally. For example, if the power supply is operating with a drive current of less than the minimum required voltage to operate the power supply under no-load conditions, then there must something wrong with the power supply.

Moreover, one power supply may have a minimum drive current of 50 mA, whereas another power supply as tested has minimum drive current of 75 mA. This means the first power supply is more efficient in that it only requires 50 mA to power-up the power supply under no-load conditions, whereas the second power supply requires 75 mA to power-up that power supply under no-load conditions. This also means that a reading of 60 mA for the second power supply indicates a problem—since at least 75 mA are required for operation, but would not be indicative of a problem relative to the more efficient first power supply that requires only 50 mA to be operational. Thus, according to the present invention, in that the controller can access the individual parameters associated with each individual power supply, the system can more accurately determine from monitoring power supply drive current, for example, whether there is a problem with a particular power supply for an electrostatic spray gun. Without such capability, control systems in the past have had to prescribe a very wide window of acceptance for a power supply parameter such as, for example, drive current. These prior control methods have allowed some electrostatic spray guns to continue to be used after their power supplies have degraded or become inoperable such that the powder coating material is no longer being effectively charged.

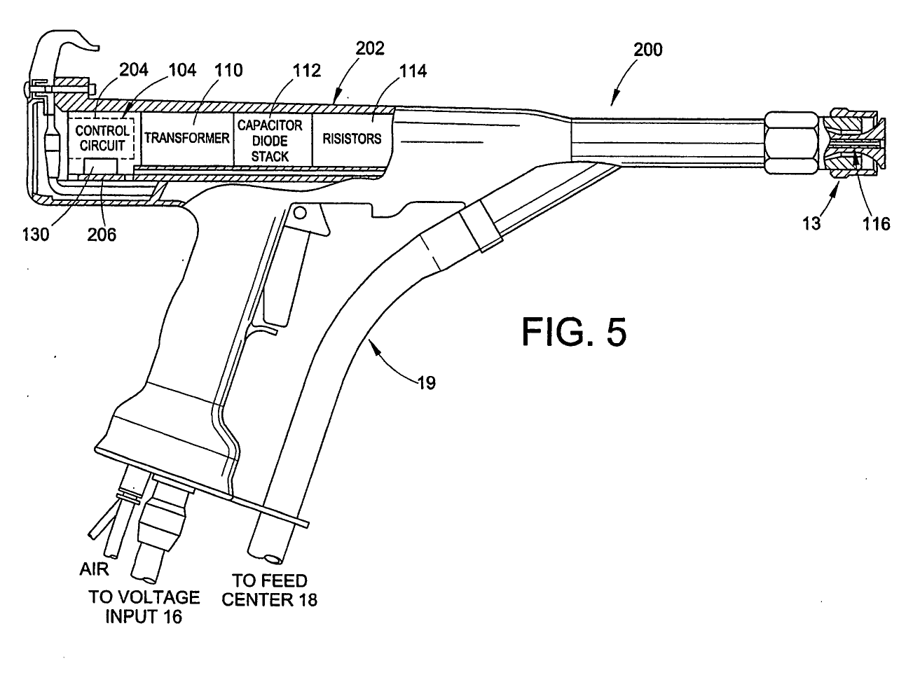

FIG. 5 illustrates in a simplified manner an embodiment for configuring an electrostatic spray gun 200 in accordance with the invention. The spray gun typically includes an external housing 202, typically made of a non-conductive material such as PVC. At the rearward end of the gun 200 is located the control circuit 104, which preferably is disposed and potted within a shielded casing 204 (represented with dashed lines in FIG. 5). The switching device 130 may be disposed on a heat sink 206 or other suitable support. Since the control circuit 104 is low voltage, it may be disposed in either the handle of the gun or may be in a rear ward extension of the housing 202 (as shown) separate from the handle. The housing 202 includes in this example the multiplier circuit 108 having the step-up transformer 110, the capacitor diode stack 112 and the resistors 114. The large feedback resistors 152 (FIG. 4A) may for example be disposed in this section as well. Note that the electronic circuitry is well isolated both electrically and thermally from the front end of the gun having the discharge electrode 116.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Additionally, information beyond the operating parameters and spray gun type identification can be included such as, for example, test facility, test operator, date of gun manufacture, maintenance intervals, etc. Therefore, the invention, in its broader aspects, is not limited to the specific details, the representative apparatus, and illustrative examples shown and described. Accordingly, departures may be made from such details without departing from the spirit or scope, of the applicant's general inventive concept.

1. An internal power supply for an electrostatic application device, comprising:
a programmable control circuit that produces a drive signal; and
a multiplier circuit that receives said drive signal and produces a voltage output;
wherein said control circuit and said multiplier are adapted to be installed in an electrostatic application device having a charging electrode coupled to said voltage output.

2. The power supply of claim 1 wherein the electrostatic application device comprises a corona spray gun.

3. The power supply of claim 1 wherein said programmable control circuit is selected from the following group: microprocessor, microcontroller, or DSP circuit.

4. The power supply of claim 1 wherein said multiplier circuit comprises a step-up transformer and Cockroft-Walton bridge circuit.

5. The power supply of claim 1 wherein said control circuit comprises memory for storing data that corresponds to operational characteristics of said power supply.

6. The power supply of claim 1 wherein said control circuit produces a time variant drive signal using a switching device coupled to a primary winding of a step-up transformer.

7. The power supply of claim 1 wherein said control circuit controls operation of the power supply in response to feedback signals from said multiplier circuit.

8. The power supply of claim 1 wherein said control circuit operates from an input DC voltage from an unregulated power supply.

9. The power supply of claim 8 wherein said power supply produces an output voltage controllable from about 0 kVolts to 30 kVolts or greater.

10. An electrostatic spray gun, comprising:
an internal power supply comprising a control circuit and a multiplier circuit;
said control circuit receiving a voltage input and producing a drive signal that is input to said multiplier circuit;
said multiplier circuit producing an output controllable from about 0 kVolts to at least 30 kVolts in response to said drive signal; said output being coupled to a charging electrode in said spray gun.

11. The spray gun of claim 10 comprising a feedback circuit for producing a feedback signal that corresponds to an operational characteristic of the power supply; wherein said control circuit controls operation of the power supply based on said feedback signal.

12. The spray gun of claim 11 wherein said feedback signal corresponds to load current or output voltage.

13. The spray gun of claim 11 wherein said control circuit is programmable and produces a controllable time variant drive signal to said multiplier circuit.

14. The spray gun of claim 10 comprising a memory circuit for storing characteristic parameters of said power supply; said control circuit controlling operation of said power supply based on comparing said stored characteristic parameters with operational information during operation of said power supply.

15. The spray gun of claim 10 wherein said control circuit comprises a switching device that is coupled to an input winding of a step-up transformer.

16. The spray gun of claim 15 wherein said switching device comprises an FET transistor.

17. The spray gun of claim 10 wherein said control circuit comprises an I/O port for communicating with an circuit external said spray gun.

18. The spray gun of claim 10 comprising a housing; said control circuit and said multiplier circuit being adapted to be installed in said housing.

19. An electrostatic spray gun, comprising:
a programmable control circuit that produces a drive signal;
a multiplier circuit that produces in response to said drive signal a voltage output signal coupled to a charging electrode;
said control circuit and said multiplier circuit forming an internal power supply adapted to be installed in the spray gun.

20. The spray gun of claim 19 wherein said multiplier circuit comprises a step-up transformer and a Cockroft-Walton bridge circuit.

21. An internal power supply for an electrostatic application device, comprising:
a programmable control circuit that produces a drive signal; and
a multiplier circuit that receives said drive signal and produces a voltage output;
wherein said control circuit and said multiplier are adapted to be installed in an electrostatic application device with said output coupled to a charging electrode;
said programmable control circuit comprising memory for storing and utilizing data and information related to the power supply.

22. An internal power supply for an electrostatic application device, comprising:
a programmable control circuit that produces a drive signal;
a feedback circuit for producing one or more feedback signals relating to characteristics of the power supply during operation; and
a multiplier circuit that receives said drive signal and produces a voltage output;
wherein said control circuit, feedback circuit and said multiplier circuit are adapted to be installed in an electrostatic application device with said output coupled to a charging electrode;
said programmable control circuit comprising memory for storing data and information related to the power supply; said programmable control circuit utilizing said stored data and said feedback signals to control the power supply during operation thereof.

23. The internal power supply of claim 22 in combination with an electrostatic spray gun, wherein the internal power supply is installed in a housing of the spray gun that supports a spray nozzle.

24. An internal power supply for an electrostatic application device, comprising:
a programmable control means for producing a drive signal; and
a multiplier means for receiving said drive signal and producing a voltage output;
wherein said programmable control means and said multiplier means are adapted to be installed in an electrostatic application device having a charging electrode coupled to said output.
